(19) United States
(12) Patent Application Publication
(10) Pub. No.: US 2026/0230404 A1
(43) Pub. Date: Aug. 6, 2026

(54) AI/ML MODEL OR AI FUNCTIONALITY MONITORING

(71) Applicant: Fraunhofer-Gesellschaft zur Förderung der angewandten Forschung e.V., München (DE)

(72) Inventors: Tatiana RYKOV, Berlin (DE); Thomas FEHRENBACH, Berlin (DE); Baris GÖKTEPE, Berlin (DE); Thomas WIRTH, Berlin (DE); Thomas SCHIERL, Berlin (DE); Cornelius HELLGE, Berlin (DE); Thomas WIEGAND, Berlin (DE)

(21) Appl. No.: 19/629,050

(22) Filed: Mar. 26, 2026

Related U.S. Application Data
(63) Continuation of application No. PCT/EP2024/076711, filed on Sep. 24, 2024.

(30) Foreign Application Priority Data
Sep. 28, 2023 (EP) 23200564.5

(51) Int. Cl. H04L 41/16; H04W 24/08; H04W 24/10; H04W 28/02

(52) U.S. Cl. CPC H04L 41/16; H04W 24/08; H04W 24/10; H04W 28/0221

(57) ABSTRACT

A user device, UE, for a wireless communication network, is disclosed. The UE is configured or preconfigured with at least one Artificial Intelligence/Machine Learning model, AI/ML model, or at least one AI functionality for performing one or more tasks. The UE is to monitor a performance of one or more AI/ML models or one or more AI functionalities. Responsive to a certain event, the UE is to perform one or more actions.

### CROSS-REFERENCE TO RELATED APPLICATIONS

This application is a continuation of copending International Application No. PCT/EP2024/076711, filed September 24, 2024, which is incorporated herein by reference in its entirety, and additionally claims priority from European Application No. 23200564.5, filed September 28, 2023, which is also incorporated herein by reference in its entirety.

### TECHNICAL FIELD

The present invention relates to the field of wireless communication systems or networks, more specifically a use of at least one Artificial Intelligence/Machine Learning model, AI/ML model, or at least one AI functionality in a wireless communication system for performing one or more tasks. Embodiments of the present invention concern improvements and enhancements when operating an AI/ML model or an AI functionality in a user device of a wireless communication system.

### BACKGROUND OF THE INVENTION

FIG. 1 is a schematic representation of an example of a terrestrial wireless network 100 including, as is shown in FIG. 1(A), the core network, CN, 102 and one or more radio access networks RAN₁, RAN₂, …RAN_{N}. FIG. 1(B) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/ LTE-A Pro, or just a BS in other mobile communication standards. The BS may also comprise of integrated access and backhaul, IAB, nodes, e.g., an IAB Donor and/or IAB Node, consisting of a central unit, CU, as well as of a distributed unit, DU, and/or containing IAB-MTs including IAB mobile termination, MT. The term base station may refer to an access point, AP, in any of the WiFi standards, e.g., belonging to the IEEE 802.11-familiy. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(B) shows an exemplary view of five cells, however, the RANₙ may include more or less such cells, and RANₙ may also include only one base station. FIG. 1(B) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(B) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁to gNB₅ may be connected to the core network 102, e.g., via the S1 interface, via respective backhaul links 114₁ to 114₅, which are schematically represented in FIG. 1(B) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁to gNB₅ may be connected, e.g., via the S1 or X2 interface or the XN interface in NR, with each other via respective backhaul links 116₁ to 116₅, which are schematically represented in FIG. 1(B) by the arrows pointing to “gNBs”. A sidelink channel allows direct communication between UEs, also referred to as device-to-device, D2D, communication. The sidelink interface in 3GPP is named PC5. Note, that the term user equipment, UE, or user device may also refer to a station, STA, as used in any of the WiFi standards, e.g., belonging to the IEEE 802.11-familiy.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 5G-Advanced or 6G or 3GPPs NR, New Radio, or within LTE-U, LTE Unlicensed or NR-U, New Radio Unlicensed, which is specified within the LTE and within NR specifications.

The wireless network or communication system depicted in FIG. 1 may be a heterogeneous network having distinct overlaid networks, e.g., a network of macro cells with each macro cell including a macro base station, like base station gNB₁to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro or 5G or 5G-Advanced or NR, New Radio, or a possible future 6G radio system.

In mobile communication networks, for example in a network like that described above with reference to FIG. 1, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

In a wireless network or communication system Artificial Intelligence (AI) and Machine Learning (ML) may be employed for certain tasks. For example, according to 3GPP, AI/ML techniques and data analytics may be incorporated into the 5G system design for supporting certain tasks, e.g., for supporting network automation, data collection for various network functions, network energy savings, load balancing, mobility optimizations, AI/ML-based services, AI/ML for the new radio (NR) air interface. For example, when considering the NR air interface, AI/ML models may be employed for one or more of the following use cases: Channel State Information (CSI): For example, AI/ML may be used for a time-domain prediction. - Beam Management (BM): For example, AI/ML may be used for a spatial and temporal prediction. - Positioning: For example, a direct AI/ML positioning approach (e.g., fingerprinting) and an AI/ML assisted positioning approach (e.g., the output of the AI/ML model inference is an additional measurement and/or an enhancement of an existing measurement) may be implemented.

The AI/ML model may be running at one of the two sides or at both sides of the communication link, e.g., at the gNB or the network-side, e.g., CN, and/or at the UE. Some AI/ML models may not be specified and left up to implementation, while others, e.g., enabling AI/ML for the air interface, need to be specified.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements to the use of AI/ML models in a wireless communication system or network.

### SUMMARY

An embodiment may have a user device, UE, for a wireless communication network, wherein the UE is configured or preconfigured with at least one Artificial Intelligence/Machine Learning model, AI/ML model, or at least one AI functionality for performing one or more tasks, wherein the UE is to monitor a performance of one or more AI/ML models or one or more AI functionalities, and wherein the UE is to perform one or more actions.

According to another embodiment, a method for operating a user device, UE, for a wireless communication network, wherein the UE is configured or preconfigured with at least one Artificial Intelligence/Machine Learning model, AI/ML model, or at least one AI functionality for performing one or more tasks, may have the steps of: monitoring, by the UE, a performance of one or more AI/ML models or one or more AI functionalities, and performing, by the UE, one or more actions.

### BRIEF DESCRIPTION OF THE DRAWINGS

Embodiments of the present invention are now described in further detail with reference to the accompanying drawings, in which:

FIGS. 1(A)-B illustrate a wireless communication network, wherein FIG. 1(A) is a schematic representation of an example of a terrestrial wireless network, and FIG. 1(B) is a schematic representation of an example of a radio access network, RAN;

FIG. 2 is a schematic representation of a wireless communication system including a transmitter, like a base station, and one or more receivers, like user devices, UEs, implementing embodiments of the present invention;

FIG. 3 illustrates a user device, UE, according to an embodiment of the present invention;

FIG. 4 illustrates a signal processing unit of a UE, like the one depicted in FIG. 3, implementing, in accordance with embodiments of the present invention, a plurality of AI/ML models/AI functionalities;

FIG. 5 illustrates a predictive AI/ML model performance monitoring in accordance with embodiments of the present invention;

FIG. 6 illustrates a multiple phase monitoring process in accordance with embodiments of the present invention; and

FIG. 7 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

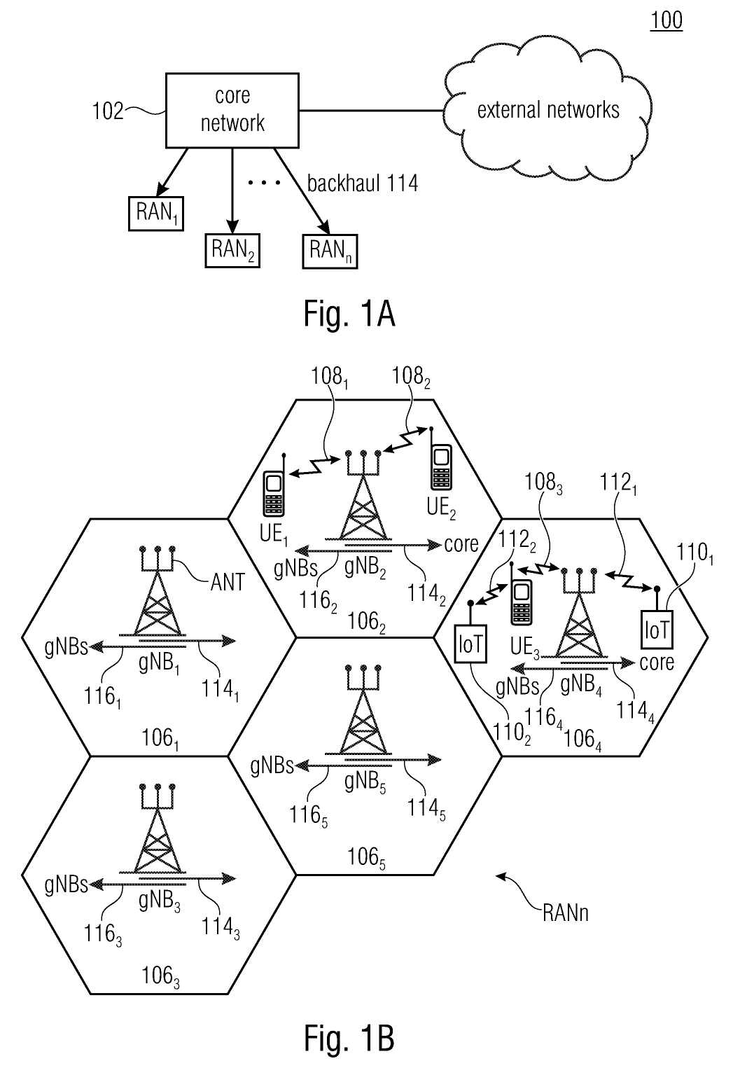

In a wireless communication system network, like the one described above with reference to FIG. 1, one or more Artificial Intelligence/Machine Learning models, AI/ML models, or one or more AI functionalities may be implemented in a user device or user equipment, UE, for performing one or more tasks, e.g., one or more of the following: AI/ML model based access to a RAN, AI/ML model based network energy saving, AI/ML model based load balancing, AI/ML model based mobility optimization, AI/ML model based use cases, like channel state information, CSI, feedback, like a CSI compression and/or a CSI prediction, or beam management, or positioning, like a direct AI/ML positioning (e.g., fingerprinting) and/or an AI/ML assisted positioning, AI/ML model based mobility management, e.g., a handover, HO, prediction and/or conditional handover, CHO, prediction, AI/ML model based modulation and coding scheme, MCS, selection, AI/ML model based synchronization, AI/ML model based encoding and/or decoding and/or precoding, AI/ML model based modulation and/or demodulation, AI/ML model based positioning or ranging, AI/ML model based joint communication and sensing, JSAC, AI/ML model based feedback calculation, e.g., channel state information, CSI, channel quality indicator, CQI, preferred matrix index, PMI, rank indicator feedback, AI/ML model based interference management, AI/ML model based quality of experience, QoE, and/or quality of service, QoS, predictions, AI/ML model based network traffic forecasting.

When implementing one or more AI/ML models or one or more AI functionalities in a wireless communication network, like a 3GPP network or a WiFi network, the overall operation of the network or an efficiency of certain functions within the network may be improved. For example, the air interface in a 5G network may be enhanced using AI/ML. The respective AI/ML models when being implemented, for example within a user device, are trained on a basis of a training dataset, and the trained AI/ML model is used for performing a certain task. However, the AI/ML model may be trained using a dataset for a certain scenario, for example a certain environment in which the user device implementing the AI/ML model is located or a certain configuration of a wireless communication link to the radio access network, RAN. For such a scenario the AI/ML model may work properly. However, when the scenario changes, for example, the environment in which the UE is located, or an operational state of the UE changes or a condition over the air interface changes, the AI/ML model currently operated in the UE may no longer yield appropriate results. For example, the AI/ML model may not operate efficiently or at its optimum so that the overall operation of the UE may degrade, for example when compared to UE not implementing the AI/ML model or a different AI/ML model being more suited for the new scenario.

Therefore, there may be a need for improvements or enhancements to the use of AI/ML models or AI functionalities in a wireless communication network, for example of AI/ML models or AI functionalities employed in a user device of the wireless communication network which avoid a degradation of the performance of the UE in case an AI/ML model or an AI functionality used for performing one or more tasks shows a degradation in its operation.

Embodiments of the present invention address the above problem by providing a user device which may be configured or preconfigured with one or more artificial intelligence/machine learning models, AI/ML models, or with one or more AI functionalities for performing one or more tasks. According to the inventive approach, the UE monitors a performance of one or more of the AI/ML models or of one or more of the AI functionalities and, responsive to a detection of a certain event, performs one or more predefined actions. The inventive approach is advantageous as it allows implementing AI/ML within a user device for exploiting the advantages of AI/ML when operating the UE and performing certain tasks, however, the above mentioned situation in which a currently used AI/ML model or AI functionality may see a degradation in its operation, for example due to a change of the environment in which the UE is located or a change of the UE operation or a change in the configuration of the air interface, is avoided, as the UE monitors a performance of the AI/ML model or a AI functionality thereby allowing the UE to take suitable actions or countermeasures in case a certain event is observed, like a degradation of the performance of the AI/ML model or AI functionality. Thereby, the inventive approach is capable to maintain the benefits of implementing AI/ML models in a user device because it is possible to take counter measures against potential degradations in the operation or efficiency of the AI/ML model which is currently used.

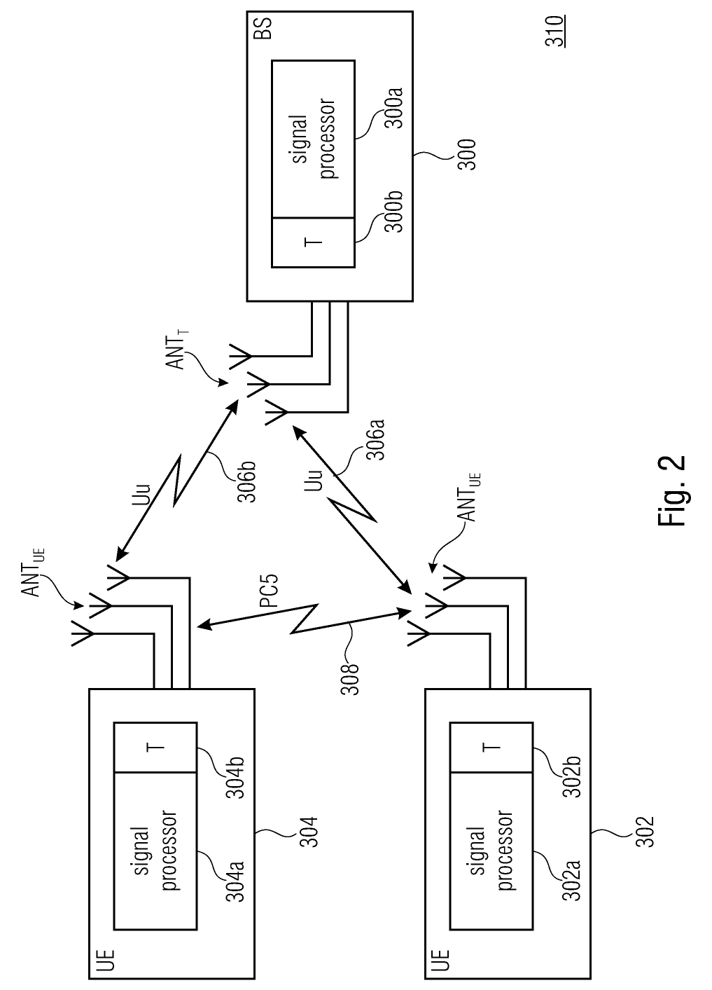

Embodiments of the present invention may be implemented in a wireless communication system as depicted in FIG. 1 including base stations and users, like mobile terminals or IoT devices. FIG. 2 is a schematic representation of a wireless communication system 310 including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 2, the one or more UEs 302, 304 of FIG. 2, and the base station 300 of FIG. 2 may operate in accordance with the inventive teachings described herein.

### User Device

The present invention provides a user device, UE, for a wireless communication network, wherein the UE is configured or preconfigured with at least one Artificial Intelligence/Machine Learning model, AI/ML model, or at least one AI functionality for performing one or more tasks, wherein the UE is to monitor a performance of one or more AI/ML models or one or more AI functionalities, and wherein, responsive to a certain event, the UE is to perform one or more actions.

In accordance with embodiments, the one or more actions comprise of one or more of the following: switch to a further AI/ML model for performing the one or more tasks, trigger a performance report for the AI/ML model or the AI functionality, send a performance report for the AI/ML model or the AI functionality, provide am AI/ML related signaling to the wireless communication network, stop using the AI/ML model for performing the one or more tasks.

In accordance with embodiments, switching the AI/ML model comprises of one or more of the following: changing the AI/ML model, changing the AI functionality, changing of AI/ML model parameters.

In accordance with embodiments, the AI/ML related signaling to the wireless communication network comprises one or more of the following: an indication that a calculation using the AI/ML model is infeasible, e.g., due to a complexity of the model or due to a battery lifetime of the UE, an AI/ML model identification, ID, of a new AI/ML model to be obtained from the wireless communication network comprises for performing the one or more tasks, a request for new training data to be used for training the AI/ML model, the performance report for the AI/ML model or the AI functionality.

In accordance with embodiments, stop using the AI/ML model for performing the one or more tasks comprises one or more of the following further actions: switch off the AI/ML model, stop performing the one or more tasks, switch to a different task, use a conventional calculation technique for performing the one or more tasks, e.g., use a look-up table or a standard CSI compression algorithm, signal to the wireless communication network that the UE stopped using the AI/ML model for performing the one or more tasks and/or the one or more further actions.

In accordance with embodiments, the AI/ML model or the AI functionality consists of one or more AI/ML models or AI/ML functionalities.

In accordance with embodiments, the certain event comprises one or more of the following: a performance of the AI/ML model is not within one or more predefined boundaries, a change in an operational situation of the UE, e.g., a change of an environment in which the UE is located, or a change in the UE operation, change in an operational condition or status of the UE.

In accordance with embodiments, for monitoring a performance of the AI/ML model, the UE is to determine one or more performance metrics for one or more key performance indicators, KPIs.

In accordance with embodiments, the one or more KPIs comprise one or more of the following: an inference accuracy, e.g., indicated as a normalized mean square error, NMSE, and/or as a squared generalized cosine similarity, SGCS, a system performance, e.g., indicated by a throughput, like a mean user perceived throughput, UPT, a block error rate, BLER, a packet error rate, PER, by a number or ratio of acknowledgements/non-acknowledgements, ACK/NACK, or a number of non-acknowledgements, NACKs, in case of NACK-only, by a latency-related information, e.g., measured in milliseconds or frame-rates, like radio frame or subframe, by switching cycles, e.g., TDD switching cycles, or by a handover success or failure rate, and the like, a data distribution, e.g., indicated as a maximum, minimum or mean value or a variance or standard deviation of the amount of data received or transmitted.

In accordance with embodiments, a performance of the AI/ML model is not within the one or more predefined boundaries in one or more of the following cases: if one of the determined performance metrics exceeds a configured or preconfigured threshold, if one of the determined performance metrics exceeds a configured or preconfigured threshold and at least a further one of the determined performance metrics exceeds a configured or preconfigured threshold, if one or more of the determined performance metrics exceed a configured or preconfigured threshold for a configured or preconfigured time, if one or more performance metrics for an inactive AI/ML model exceed the corresponding performance metrics for an active AI/ML model by a configured or preconfigured threshold, if a number or percentage of performance metric outliers and/or a magnitude of the outliers exceeds a configured or preconfigured threshold, if a time since one or more of an activation of the AI/ML model for which the performance report is to be triggered, or a switch to the AI/ML model for which the performance report is to be triggered, or a change of parameters of the AI/ML model for which the performance report is to be triggered, or a last performance report for the AI/ML model was triggered exceeds a configured or preconfigured minimum time.

In accordance with embodiments, the UE is to determine the one or more performance metrics over a configured or preconfigured measurement window defining a time over which the determined performance metrics are averaged, e.g., as a uniform average or as a weighted average, and/or a number of determined performance metrics to be averaged, e.g., as a uniform average or as a weighted average.

In accordance with embodiments, the weighted average is according to an exponential or negative exponential function.

In accordance with embodiments, the UE is to extend or shorten the measurement window depending on one or more of: a certain amount of measurements, a certain amount of measurement outliers, a certain amount of values inside a confidence interval, a confidence interval, an error magnitude or error vector magnitude, EVM.

In accordance with embodiments, monitoring the performance of the AI/ML model comprises one or more of: using the AI/ML model with a dataset for a current scenario, which is selected from a set of datasets for a plurality of scenarios with which the AI/ML model has been trained, for obtaining the one or more performance metrics, comparing the one or more performance metrics with one or more configured or preconfigured thresholds, in case the comparison indicates that the current scenario has changed to a different scenario of a plurality of scenarios, triggering the monitoring of the AI/ML model using a dataset for the different scenario, sending the results of the monitoring of the AI/ML model using a dataset for the current scenario to one or more entities of the wireless communication network.

In accordance with embodiments, a scenario corresponds to one or more of the following: an operational situation, e.g., a change of an environment, a UE operation, groups of UEs with similar operational situations, a topology of a network, e.g., a macro topology, a small cell topology, a RAN topology including IAB-nodes, a topology including relay nodes, RN, or a topology including connectivity via a non-terrestrial network, NTN.

In accordance with embodiments, wherein the UE is configured or preconfigured with a plurality of AI/ML models, the plurality of AI/ML models comprises one or more active AI/ML models currently used by the UE for performing the one or more tasks, and one or more inactive AI/ML models currently not used by the UE for performing the one or more tasks, and the UE is to monitor the performance of the active AI/ML model and/or the performance of the one or more inactive AI/ML models.

In accordance with embodiments, if one or more of the performance metrics of the active AI/ML model exceed a configured or preconfigured threshold, the UE is to switch to a monitoring of an inactive AI/ML model, or if one or more of the performance metrics of a monitored inactive AI/ML model exceed a configured or preconfigured threshold, the UE is to switch to a monitoring of a further inactive AI/ML model, or if an indication has been provided that the UE switched to the further AI/ML model, the UE is to switch to a monitoring of the further AI/ML model.

In accordance with embodiments, for switching to the further AI/ML model for performing the one or more tasks, the UE is to deactivate the active AI/ML model and activate one of the inactive AI/ML models.

In accordance with embodiments, the UE is to trigger a performance report for the active AI/ML model and/or the one or more monitored inactive AI/ML models.

In accordance with embodiments, the UE is to provide the performance report to one or more entities of the wireless communication network, e.g., to another UE or to a Radio Access Network, RAN, entity, like a gNB, or to a core network, CN, entity.

In accordance with embodiments, the UE is to provide the performance report periodically, or responsive to the certain event.

In accordance with embodiments, the performance report includes data representing the determined performance metrics, e.g., one or more of the following: processed, e.g., averaged, performance data representing one or some or all of the determined performance metrics, or non-processed performance data representing one or some or all of the determined performance metrics, specific performance data representing only a proper subset of the determined performance metrics, e.g., only outliers or an average of the outliers, like an error magnitude of the outliers.

In accordance with embodiments, the performance report further includes one or more of the following: an index, like an integer, representing an index of a performance report configuration with which the UE is configured, any decision related to a conditional monitoring model switch/past decisions, e.g., a list of AI/ML monitored models related to past actions over a period of time, one or more timestamps. measurement window parameters, like a duration or length, a number of samples, a confidence interval, one or more conditions which trigger the performance report.

In accordance with embodiments, the performance report includes an indication that the UE switched to the further AI/ML model and an index, like an integer, representing an index of a performance report configuration with which the UE is configured and which corresponds to the further AI/ML model.

In accordance with embodiments, the AI/ML model is a predictive AI/ML model, and the UE is to monitor a performance of the predictive AI/ML model by comparing one or more predicted values obtained from the predictive AI/ML model and one or more corresponding measured values obtained by the UE.

In accordance with embodiments, the UE is to trigger or is to trigger and send a performance report for the predictive AI/ML model if a mismatch between one or more of the predicted values and the more corresponding measured values exceeds a configured or preconfigured threshold.

In accordance with embodiments, the performance report for the predictive AI/ML model is triggered or triggered and sent if the threshold or an average of the threshold over a first time interval is exceeded once, or a configured or preconfigured number of times during a second time interval.

In accordance with embodiments, the performance report for the predictive AI/ML model includes one or more of the following: one or more adaption parameters to re-align the predictive AI/ML mode, an AI/ML model update after re-training, a magnitude of the mismatch, e.g., mismatch between one or more of the predicted values, an indication that a re-training of the predictive AI/ML model is required, a request for changing from the predictive AI/ML model to a currently inactive predictive AI/ML model also monitored by the UE, a confirmation that the UE switched or will switch from the predictive AI/ML model to a currently inactive predictive AI/ML model also monitored by the UE.

In accordance with embodiments, the UE is to monitor the AI/ML model during a plurality of monitoring phases, and the plurality of monitoring phases comprises a first monitoring phase having a monitoring configuration which is different from a monitoring configuration of a second monitoring phase.

In accordance with embodiments, the UE is to adapt and/or validate the one or more active AI/ML models or functionalities during the second monitoring phase.

In accordance with embodiments, adapting the AI/ML model or functionalities comprises one or more of the following: switching the AI/ML model, updating the AI/ML model parameters.

In accordance with embodiments, the UE is to switch between the first monitoring phase and the second monitoring phase responsive to one or more conditions.

In accordance with embodiments, the conditions comprise one or more of the following: a change in an AI/ML model configuration, a triggering of a performance report, a time condition, e.g., based on a configured or preconfigured timer, periodically or aperiodically, an indication from the network or from another UE, if one of the determined performance metrics exceeds a configured or preconfigured threshold, if one of the determined performance metrics exceeds a configured or preconfigured threshold and at least a further one of the determined performance metrics exceeds a configured or preconfigured threshold, if one or more of the determined performance metrics exceed a configured or preconfigured threshold for a configured or preconfigured time, if one or more performance metrics for an inactive AI/ML model exceed the corresponding performance metrics for an active AI/ML model by a configured or preconfigured threshold, if a number or percentage of performance metric outliers and/or a magnitude of the outliers exceeds a configured or preconfigured threshold, if a time since one or more of an activation of the AI/ML model for which the performance report is to be triggered, or a switch to the AI/ML model for which the performance report is to be triggered, or a change of parameters of the AI/ML model for which the performance report is to be triggered, or a last performance report for the AI/ML model was triggered exceeds a configured or preconfigured minimum time.

In accordance with embodiments, the UE is to switch from the second monitoring phase to the first monitoring phase dependent on a battery lifetime of the UE, e.g., in case the UE has battery limitations, e.g., is low on battery.

In accordance with embodiments, the UE is configured with the plurality of monitoring phases via a performance monitoring configuration or via a separate pre-configuration, or the UE is to receive a signaling indicating whether the plurality of monitoring phases are to be used or not to be used during monitoring.

In accordance with embodiments, the UE is to receive a performance report configuration for configuring the reporting of the AI/ML model.

In accordance with embodiments, the performance report configuration includes one or more of the following: an index, like an integer, representing the performance report configuration, an AI/ML model identification, ID, like a model identification number, indicating for which AI/ML model the performance report is to be provided, an AI/ML-model mode indicating whether the performance report is to be provided for an active or inactive AI/ML-model, the one or more performance metrics, the one or more thresholds for the performance metrics that trigger the performance report, one or more reporting conditions triggering the performance report, a reporting periodicity, a measurement window size, one or more thresholds for allowing switching to an inactive AI/ML model to be monitored, a hysteresis to avoid switching between AI/ML models during a certain time after the last switch or before an additional delta threshold is exceeded since the last switch.

In accordance with embodiments, the one or more of tasks comprise one or more of the following: AI/ML model based access to a RAN, AI/ML model based network energy saving, AI/ML model based load balancing, an AI/ML model based mobility optimization, AI/ML model based use cases, like channel state information, CSI, feedback, like a CSI compression and/or a CSI prediction, or beam management, or positioning, like a direct AI/ML positioning (e.g., fingerprinting) and/or an AI/ML assisted positioning, AI/ML model based mobility management, e.g., a handover, HO, prediction and/or conditional handover, CHO, prediction, AI/ML model based modulation and coding scheme, MCS, selection, AI/ML model based synchronization, AI/ML model based encoding and/or decoding and/or precoding, AI/ML model based modulation and/or demodulation, AI/ML model based positioning or ranging, AI/ML model based joint communication and sensing, JSAC, AI/ML model based feedback calculation, e.g., CSI/CQI/PMI/RI feedback, AI/ML model based interference management, AI/ML model based quality of experience, QoE, and/or quality of service, QoS, predictions, AI/ML model based network traffic forecasting.

In accordance with embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IoT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### System

The present invention provides a wireless communication system, like a 3^{rd} Generation Partnership Project, 3GPP, system, comprising a one or more user devices, UEs, according to the present invention and/or one or more base stations, BSs.

In accordance with embodiments, the BS comprises one or more of a macro cell base station, or a small cell base station, or a central unit of a base station, or a distributed unit of a base station, or an Integrated Access and Backhaul, IAB, node, or a road side unit, RSU, or a WiFi access point, AP, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Method

The present invention provides a method for operating a user device, UE, for a wireless communication network, wherein the UE is configured or preconfigured with at least one Artificial Intelligence/Machine Learning model, AI/ML model, or at least one AI functionality for performing one or more tasks, the method comprising: monitoring, by the UE, a performance of one or more AI/ML models or one or more AI functionalities, and responsive to a certain event, performing, by the UE one or more actions.

The present invention provides a computer program product comprising instructions which, when the program is executed by a computer, causes the computer to carry out one or more methods in accordance with the present invention.

Embodiments of the present invention are now described in more detail with reference to the accompanying drawing. It is noted that the subsequently outlined and described aspects or embodiments may be combined such that some or all of the aspects/embodiments are implemented within one embodiment. Reference is made herein one or more AI/ML models and/or to one or more AI functionalities. It is noted that when referring only to an AI/ML model, this is to be understood to refer also to an AI functionality, and that when referring only to an AI functionality, this it to be understood to refer also to an AI/ML model. AI functionality may refer to an AI/ML-enabled Feature/Feature Group, FG, enabled by one or more configurations, where the one or more configurations may be supported based on one or more conditions indicated by a UE capability. An AI/ML-enabled Feature refers to a Feature where AI/ML may be used. It is noted that a UE may have one AI/ML model for the functionality, or the UE may have multiple AI/ML models for the functionality. Examples of use cases for AI/ML-enabled Features or Feature Groups are: CSI feedback enhancement, e.g., overhead reduction, improved accuracy, prediction. Beam management, e.g., beam prediction in time, and/or spatial domain for overhead and latency reduction, beam selection accuracy improvement. Positioning accuracy enhancements for different scenarios including, e.g., those with heavy NLOS conditions.

Other examples may comprise of access to the RAN, network energy saving, NES, resource management and load balancing, mobility enhancements and optimization including handover, HO, management and/or prediction, conditional handover, CHO, management and/or prediction, modulation and coding scheme, MCS, selection, MIMO precoder calculation, general PHY-layer signal processing, e.g., synchronization, channel coding or decoding, modulation or demodulation, positioning or ranging, joint communication and sensing, JSAC, feedback calculation of CSI/CQI or PMI/RI, general MIMO processing, equalization, interference management, quality of experience, QoE, and/or quality of service, QoS, predictions, and/or network traffic forecasting. It is noted that the AI/ML approaches for the selected sub use cases need to be diverse enough to support various requirements on the gNB-UE collaboration levels.

An AI/ML model operates based on identified models, where a model may be associated with one or more specific configurations/conditions associated with a UE capability of an AI/ML-enabled Feature/FG and additional conditions (e.g., scenarios, sites, and datasets) as determined/identified between the UE-side and the NW-side.

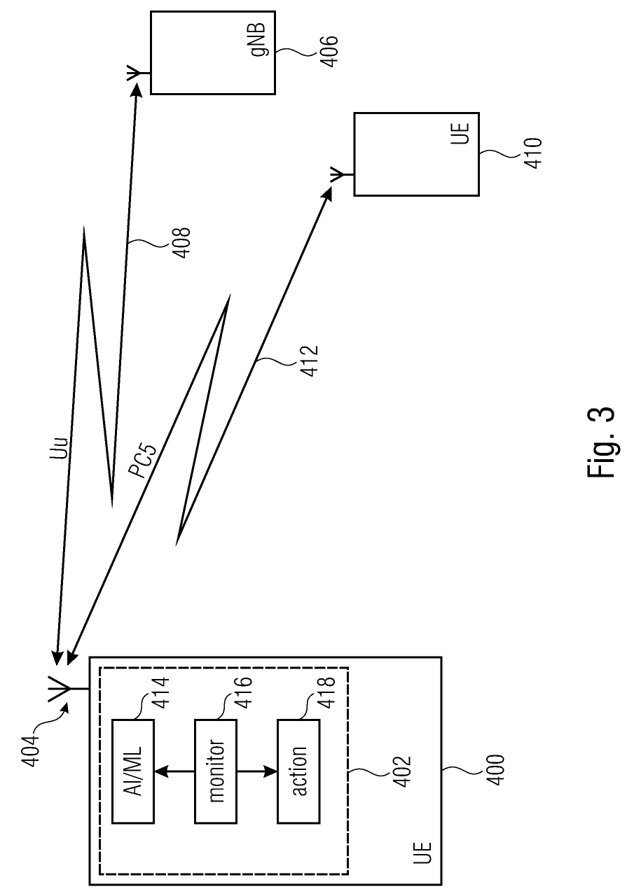

FIG. 3 illustrates a user device, UE, in accordance with embodiments of the present invention. The UE 400 includes a signal processing unit or signal processor 402 and one or more antennas or an antenna array 404 for communicating with other network entities over the air interface. As is depicted in FIG. 3, the UE 400 may communicate, for example, with a base station or gNB 406 using, for example, the Uu interface 408 and/or with a further UE 410 using the PC5 interface 412 for a sidelink, SL, communication. The UE 400 is configured or preconfigured with at least one AI/ML model or at least one AI functionality 414 for performing one or more tasks. The UE 400 monitors a performance of one or more AI/ML models or of one or more AI functionalities, as is illustrated at 416. Responsive to a certain event, the UE 400 performs one or more actions, as is illustrated at 418.

In accordance with embodiments, the monitoring 416 of the AI/ML model 414 by the UE 400 may be based on a generalization of the AI/ML model 414 which describes how the AI/ML model may adapt to new data. The generalization of the AI/ML model may be considered one of the key capabilities for evaluating the performance of the AI/ML model 414. For example, when considering a 3GPP wireless communication network, the following cases may be considered for verifying a generalization performance of an AI/ML model considering various scenarios/configurations: Case 1: AI/ML model 414 is trained based on a dataset from Scenario #A/Configuration#A, and then the AI/ML model 414 performs an inference or test on a dataset for the same scenario/configuration, i.e., on a dataset for Scenario#A/Configuration#A. Case 2: AI/ML 414 model is trained based on dataset from a Scenario#A/Configuration#A, and then the AI/ML model performs an inference or test on a dataset different from Scenario#A/Configuration#A, for example on a dataset from Scenario#B/Configuration#B or from Scenario#A/Configuration#B. Case 3: AI/ML model 414 is trained based on a dataset constructed by mixing datasets from multiple scenarios/configurations including a first Scenario#A/Configuration#A and a second dataset different from the first scenario/configuration, for example, a dataset from Scenario#B/Configuration#B or Scenario#A/Configuration#B, and then the AI/ML 414 model performs an inference or test on a dataset from a single scenario/configuration from the multiple scenarios/configurations, e.g., Scenario#A/Configuration#A, or Scenario#B/Configuration#B, or Scenario#A/Configuration#B. It is noted that the number of multiple scenarios/configurations may be larger than 2. Also, ratio of dataset mixing may be reported.

When considering the use case of an AI/ML based CSI prediction, scenarios considered for the generalization performance may include the following parameters: UE speed: 10km/h, 30km/h, 60km/h, 120km/h. UE location: indoor, outdoor, line of sight (LOS), or non-LOS. UE configuration: antenna configuration, e.g., number of antennas or antenna arrays, Input/output type: raw channel matrix or quantized channel matrix or eigenvectors. Observation window: 5/5ms, 10/5ms, i.e., number of historic CSI/channel measurements in the observation window/time distance of the historical CSI/channel measurements. Prediction window: 1/5ms, 5ms, i.e., number/time distance of predicted CSI/channel.

When considering that the performance of the AI/ML based CSI prediction changes with the change of speed, scenario, observation window and prediction window, the present invention allows for a real time performance monitoring. In accordance with embodiments of the present invention, the monitoring 416 at the UE 400 may include the above described generalization of the one or more AI/ML models or AI functionalities used at the UE 400 for monitoring their performance.

In accordance with embodiments, the one or more actions comprise of one or more of the following: Switch to a further AI/ML model for performing the one or more tasks. Trigger a performance report for the AI/ML model or the AI functionality. Send a performance report for the A/ML model or the AI functionality. Provide an AI/ML related signaling to the wireless communication network. Stop using the AI/ML model for performing the one or more tasks.

Switching the AI/ML model may include one or more of changing the AI/ML model, changing the AI functionality and changing of AI/ML model parameters.

The AI/ML related signaling to the wireless communication network may include one or more of: An indication that a calculation using the AI/ML model is infeasible, e.g., due to a complexity of the model or due to a battery lifetime of the UE. An AI/ML model identification, ID, of a new AI/ML model to be obtained from the wireless communication network comprises for performing the one or more tasks. The new model may be less complex for the calculation. The new model may be more complex but delivers a better result. This may be used, e.g., in case a UE has additional processing capabilities available and/or in case the timing is more relaxed, so that a more complex calculation may be performed. A request for new training data to be used for training the AI/ML model.

For example, additional training data may help the UE to perform the calculation faster or with a higher precision. A performance report for the AI/ML model or the AI functionality.

Stop using the AI/ML model for performing the one or more tasks may include one or more of the following further actions: Switch off the AI/ML model. Switch off the AI/ML model/AI/ML functionality in favor of switching on another AI/ML model/AI/ML functionality at the UE with limited AI/ML related resources. Stop performing the one or more tasks to save AI/ML related resources of the UE, e.g., processing power usage, available memory, battery lifetime. Furthermore, this may include using a conventional calculation technique for performing the one or more tasks. Switch to a different task that uses less AI/ML related resources of the UE, e.g., an algorithm using more efficiently the processing power and/or the available memory, and/or consuming less battery. Use a conventional calculation technique for performing the one or more tasks, e.g., use a look-up table or a standard CSI compression algorithm. Signal to the wireless communication network that the UE stopped using the AI/ML model for performing the one or more tasks and/or the one or more further actions.

In accordance with embodiments, the AI/ML model or the AI functionality may not be just a single model/functionality but may be a bundle or set of models/functionalities. For example, the AI/ML model or the AI functionality may combine or consists of two or more models/functionalities.

In accordance with embodiments, the certain event may be a change in an operational situation of the UE. For example, an environment in which the UE is located may have changed which may lead to a change in an interference situation so that the UE experiences a different interference situation, e.g., a higher or lower interference. The change in an interference situation may also be caused by a base station which configures a subband non-overlapping full duplex, SBFD, operation so that the UE may experience a different interference situation in this case, e.g., an interference from a neighboring BS and/or UE. Other examples for a change of the UE’s environment may be a change of the network congestion situation, that the UE moves out of coverage of a base station, that the UE performs a handover or conditional handover, CHO, that the UE performs roaming, that the UE moves between indoor/outdoor, that the UE moves from a small cell or IAB node or relay node to a Macro BS or vice versa.

Another example for a change in an operational situation of the UE may be a change in the UE operation. For example, the calculation for which the AI/ML model or AI functionality is used is not required anymore. This may be the case if the UE has to switch from transmission to reception, e.g., in case of a UE operating in TDD, or in if the UE performs a handover or conditional handover, CHO, to another base station, of if the UE is configured to not send feedback data, which was the purpose of using AI/ML calculation, e.g., for providing the CSI feedback like a CSI compression, or for a positioning-related calculation like positioning feedback information, or for providing other MIMO feedback like a selection of a pre-coder and/or a beam, or for providing a HARQ-feedback like ACK/NACK or NACK-only feedback information.

In accordance with yet further embodiments, the certain event may be a change in an operational condition or status of the UE. For example, a battery status or power consumption of the UE may reach certain limits. The battery may be low, i.e., below a configured or preconfigured threshold, or the power consumption may be above a configured or preconfigured threshold. Another example is that the UE’s discontinuous reception, DRX, time is below a configured or preconfigured threshold. Other examples for a change of the UE’s operational condition or status include a memory status, like a storage or buffer reaching a limit, that the UE’s speed has changed, that the UE’s channel type has changed (e.g., from line of sight, LOS, to non-line of sight, NLOS, or vice versa, that the UE’s antenna is obstructed, that a rank of a radio channel changed, e.g., is increased or decreased, that a switch to a different carrier frequency occurred, e.g., from FR1 to FR2 or vice versa.

In accordance with embodiments, the certain event may be that a performance of the AI/ML model is not within one or more predefined boundaries. For example, for monitoring a performance of the AI/ML model, the UE determines one or more performance metrics for one or more key performance indicators, KPIs, indicating, e.g., an inference accuracy, a system performance. The inference accuracy may be indicated as a normalized mean square error, NMSE, and/or as a squared generalized cosine similarity, SGCS. The system performance may be indicated by a throughput, like a mean user perceived throughput, UPT, a block error rate, BLER, a packet error rate, PER, a number or ratio of acknowledgements/non-acknowledgements, ACK/NACK, or a number of non-acknowledgements, NACKs, in case of NACK-only, a latency-related information, e.g., measured in milliseconds or frame-rates, like radio frame or subframe, switching cycles, e.g., TDD switching cycles, or a handover success or failure rate.

The data distribution may be indicated as a maximum, minimum or mean value or a variance or standard deviation of the amount of data received or transmitted.

In accordance with embodiments, a performance of the AI/ML model is not within the one or more predefined boundaries in one or more of the applies cases: if one of the determined performance metrics exceeds a configured or preconfigured threshold, if one of the determined performance metrics exceeds a configured or preconfigured threshold and at least a further one of the determined performance metrics exceeds a configured or preconfigured threshold, if one or more of the determined performance metrics exceed a configured or preconfigured threshold for a configured or preconfigured time, if one or more performance metrics for an inactive AI/ML model exceed the corresponding performance metrics for an active AI/ML model by a configured or preconfigured threshold, if a number or percentage of performance metric outliers and/or a magnitude of the outliers exceeds a configured or preconfigured threshold, if a time since one or more of an activation of the AI/ML model for which the performance report is to be triggered, or a switch to the AI/ML model for which the performance report is to be triggered, or a change of parameters of the AI/ML model for which the performance report is to be triggered, or a last performance report for the AI/ML model was triggered exceeds a configured or preconfigured minimum time.

In accordance with further embodiments, the UE determines the one or more performance metrics over a configured or preconfigured measurement window defining a time over which the determined performance metrics are averaged, e.g., as a uniform average or as a weighted average, and/or a number of determined performance metrics to be averaged, e.g., as a uniform average or as a weighted average.

The weighted average may be according to an exponential or negative exponential function. Further, the UE may extend or shorten the measurement window depending on one or more of: a certain amount of measurements, a certain amount of measurement outliers, a certain amount of values inside a confidence interval, a confidence interval, an error magnitude or error vector magnitude, EVM. Outliers: values which are outside a certain range, dependent on a configured threshold or confidence interval Confidence interval: the probability that a population parameter will fall between a set of values for a certain proportion of times, e.g., 95% or 99% of measurement values fall within a certain range. Note, that the confidence interval depends on the underlying distribution, e.g., Stundent-T distribution, normal distribution, Xi-squared distribution, etc. EVM: Error Vector Magnitude (EVM) is a measure used to quantify the accuracy of a digital communication system. It represents the difference between the ideal transmitted signal and the received signal after demodulation and decoding. EVM is typically expressed as a percentage and indicates the level of distortion or error in the received signal.

The monitoring may be a continuous evaluation of the AI/ML model or AI functionality by means of one of the following approaches: A monitoring based on an inference accuracy, including metrics related to KPIs. A monitoring based on system performance, including metrics related to system performance KPIs. A monitoring based on data distribution.

To provide a sustainable quality of the AI/ML model performance, e.g., a CSI prediction, during the possible changes of the scenarios, the monitoring of multiple models may have to be conducted by the UE, which might have negative impact on the limited UE’s internal capabilities, like memory or battery. To address such a situation and avoiding the impact on the limited UE’s internal capabilities, embodiments of the present invention provide a so-called conditional monitoring according to which (1) Monitoring the performance of the AI/ML model may include using the AI/ML model with a dataset for a current scenario, which is selected from a set of datasets for a plurality of scenarios with which the AI/ML model has been trained, for obtaining the one or more performance metrics. For example, a model with mixed dataset (generalization case 3 – see above) may be used for monitoring purposes. For example, if the monitoring for a CSI prediction use case based on the KPIs is used, the prediction accuracy in terms of NMSE/SGCS may be computed. (2) Comparing the one or more performance metrics with one or more configured or preconfigured thresholds, if the comparison indicates that the current scenario has changed to a different scenario of a plurality of scenarios, triggering the monitoring of the AI/ML model using a dataset for the different scenario, and (3) Optionally, sending the results of the monitoring of the AI/ML model using a dataset for the current scenario to one or more entities of the wireless communication network. E.g., for the decision-making purposes.

By applying the conditional monitoring, an amount of signaling overhead sent to the network NW may be significantly reduced. Moreover, the network may configure a set of models that the UE may switch to autonomously by performing conditional monitoring without sending any feedback back the NW.

A scenario among the plurality of scenarios may correspond to a certain operational situation, e.g., a change of an environment, to a certain UE operation, two groups of UEs with similar operational situations, or to a topology of a network, e.g., a macro topology, a small cell topology, a RAN topology including IAB-nodes, a topology including relay nodes, RN, or a topology including connectivity via a non-terrestrial network, NTN.

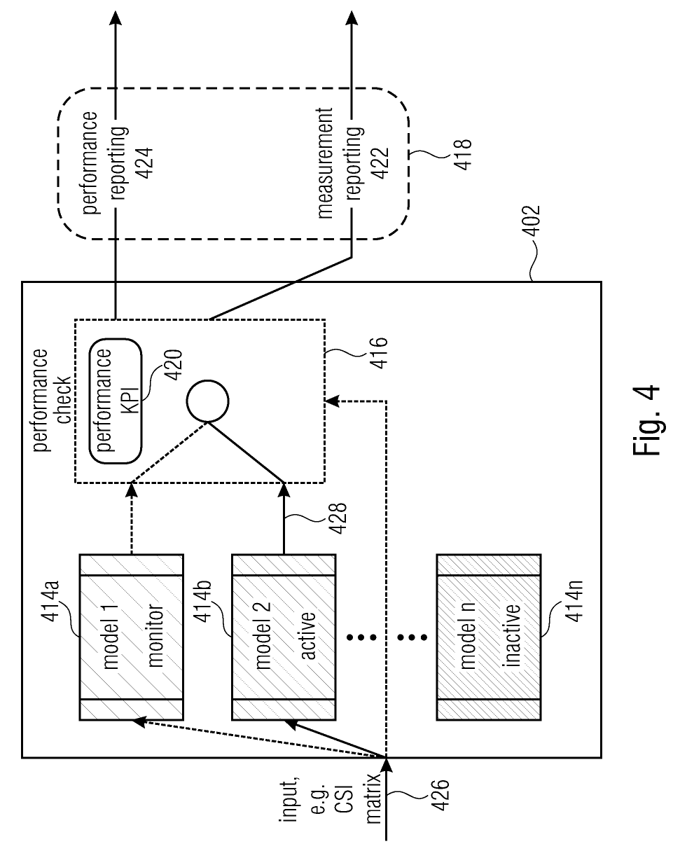

In the embodiments described so far, it has been assumed that the UE 400 is configured or preconfigured with one AI/ML model or one AI functionality 414. However, the present invention is not limited to such embodiments, rather, in accordance with further embodiments, the UE 400 may be configured or preconfigured with a plurality of AI/ML models or AI functionalities. FIG. 4 illustrates a signal processing unit 402 of a UE, like the one depicted in FIG. 3, in accordance with embodiments of the present invention. The UE 400 is configured or preconfigured with a plurality of AI/ML models or AI functionalities 414a to 414n. Among the plurality of AI/ML models, there is one active AI/ML model 414b which is currently used by the UE 400 for performing the one or more tasks, while the remaining AI/ML models 414a, 414n are inactive, i.e., are currently not used by the UE 400 for performing the one or more tasks. In accordance with embodiments, the UE 400 monitors the active AI/ML model 414b and carries out a performance check using respective performance KPIs as is indicated at 420. In accordance with embodiments, for monitoring the performance of the AI/ML model 414b input data 426, for example a CSI matrix, is input into the AI/ML model 414b which outputs the CSI prediction 428 which is monitored so as to determine whether the CSI prediction is in line with respective KPI metrics 420 to be fulfilled for the CSI feedback process. Responsive to a certain event, like one of the above-mentioned events, the UE 400 may perform one or more of the above-mentioned actions 418. For example, when it is determined that the CSI prediction is not in line with the respective KPI metrics 420, the measurements 422 made by the UE 400 and/or the performance 424 of the AI/ML model 414b determined by the UE 400 may be reported. The reporting may be towards the network, and the UE may provide the measurement report 422 and/or the performance report 424 to one or more entities of the wireless communication network, for example to another UE, like UE 410, or to a radio access network, RAN, entity, like the gNB 406 in FIG. 3, or to a core network entity. For example, when directing the performance reporting 424 to a core network entity it may be directed to a general AI/ML network function or to a AI/ML server, or to a specific network function, NF, e.g., a Beamforming-AI/ML-NF or to a Positioning-AI/ML-NF, or to a legacy NF, e.g., the location management function, LMF. In FIG. 4 the input, i.e., the CSI/channel measurements may be applied to the performance check to monitor the AI/ML model’s performance, e.g., a predication accuracy in terms of NMSE/SGCS between predicted and actual or measured channel values.

Although it has been described above that among the plurality of AI/ML models there is only one active AI/ML model 414b which is currently used by the UE 400 for performing the one or more tasks, it is noted that the present invention is not limited to such an embodiment. In accordance with further embodiments, there may be a plurality of active AI/ML models which are currently used by the UE 400 for performing the one or more tasks, and the UE 400 may monitor one or some or all of the active AI/ML models.

In accordance with embodiments, instead of monitoring the one or more active AI/ML models, like AI//ML model 414b, the UE 400 may monitor one or more of the inactive AI/ML models, in the embodiment of FIG. 4 only inactive AI/ML model 414a. In accordance with other embodiments, both the one or more active AI/ML models and one or more of the inactive AI/ML models 414a, 414n may be monitored for their performance.

In accordance with other embodiments, rather than monitoring inactive and active AI/ML models at the same time, the UE may switch from monitoring the currently used or active AI/ML model to monitoring a currently inactive AI/ML model, for example in case the performance of the active AI/ML model is no longer within the predefined boundaries, for example, no longer meets the performance KPI metrics. When monitoring an inactive AI/ML model and determining that it does not perform in accordance with the desired requirements, the UE may switch to the monitoring of a different inactive AI/ML model. The switching among AI/ML models includes deactivating a currently used AI/ML model or AI/functionality and activating one or more of currently unused or inactive AI/ML models or AI functionalities. In accordance with embodiments, monitoring the inactive and/or active AI/ML models may also include triggering the performance report for the active or inactive AI/ML models.

The embodiment of FIG. 4 is advantageous as it allows monitoring not only a currently used AI/ML model but also currently inactive AI/ML models. For example, in case several AI/ML models or AI functionalities are provided for the same tasks or for similar tasks, the UE 400 may apply the input data to the active AI/ML model and also to one or more inactive AI/ML models so as to monitor the performance of the respective AI/ML models thereby allowing the UE to determine situations in which a currently used AI no longer performs as desired which enables the UE to switch to a currently inactive AI/ML model which it determined to operate better or to fulfill the predefined requirements for the AI/ML model.

The UE may provide the performance report 424 periodically or responsive to one of the above-mentioned events, e.g., in case one or more of the above-mentioned thresholds for one or more of the determined performance metrics are exceeded.

In accordance with embodiments, the performance report includes data representing the determined performance metrics, e.g., one or more of the following: processed, e.g., averaged, performance data representing one or some or all of the determined performance metrics, or non-processed performance data representing one or some or all of the determined performance metrics, specific performance data representing only a proper subset of the determined performance metrics, e.g., only outliers or an average of the outliers, like an error magnitude of the outliers.

The performance report may include one or more of the following: an index, like an integer, representing an index of a performance report configuration with which the UE is configured, any decision related to a conditional monitoring model switch/past decisions, e.g., a list of AI/ML monitored models related to past actions over a period of time, one or more timestamps indicating, e.g., one or more of the following: a timestamp indicating when the report was generated, a time window or timestamp of when the KPIs where measured, a validity of the interval when the report may be applied, a timestamp of when the AI/ML model or AI functionality was switched to or how long the AI/ML model or AI functionality has been active, a time of when next report(s) would be available, measurement window parameters, like a duration or length, a number of samples, a time distance between the samples, a confidence interval, one or more conditions which trigger the performance report, request for an adaption of AI/ML model parameters for re-aligning the AI/ML model, i.e., changing the values of AI/ML model parameters to optimize the AI/ML model’s performance, e.g., that the AI/ML model requires less computational complexity or achieves more accurate prediction results.

If the performance report is provided responsive to the switching to a further or different AI/ML model/AI functionality, it may include, in addition to the indication that the UE switched to the further AI/ML model, an index, like an integer, representing an index of a performance report configuration with which the UE is configured and which corresponds to the further AI/ML model.

In accordance with embodiments, the UE 400 receives a performance report configuration for configuring the reporting of the AI/ML model or AI functionality. For example, the performance report configuration may include one or more of the following: an index, like an integer, representing the performance report configuration, an AI/ML model identification, ID, like a model identification number, indicating for which AI/ML model the performance report is to be provided, an AI/ML-model mode indicating whether the performance report is to be provided for an active or inactive AI/ML-model, the one or more performance metrics, the one or more thresholds for the performance metrics that trigger the performance report, one or more reporting conditions triggering the performance report, a reporting periodicity, a report validity timer, e.g., a report is valid for a certain number of radio frames or up to a certain absolute timestamp, a measurement window size, one or more thresholds for allowing switching to an inactive AI/ML model to be monitored, a hysteresis to avoid switching between AI/ML models during a certain time after the last switch or before an additional delta threshold is exceeded since the last switch.

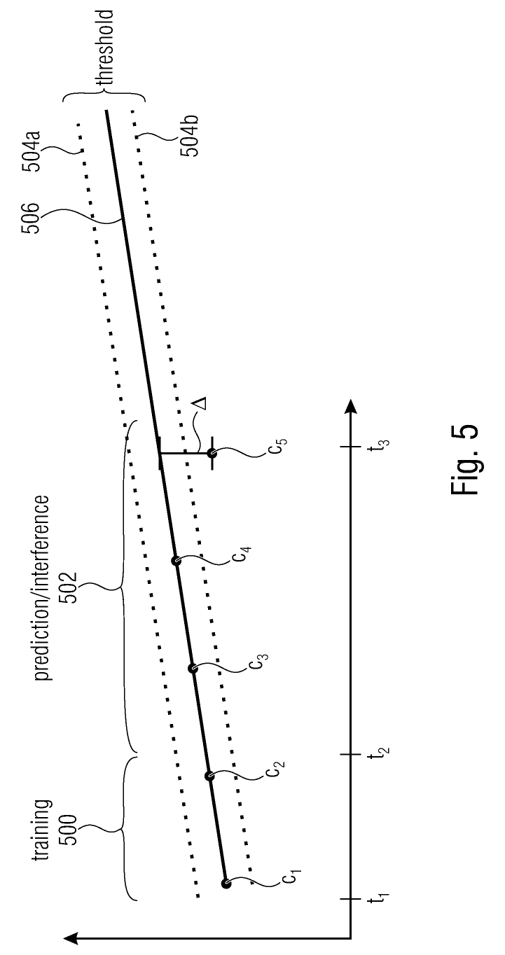

In accordance with further embodiments of the present invention, the UE may be configured or preconfigured with one or more predictive AI/ML models or predictive AI functionalities. The UE 400 performs a predictive AI/ML model performance monitoring by comparing one or more predicted values obtained from the predictive AI/ML model and one or more corresponding measured values obtained by the UE. FIG. 5 illustrates a predictive AI/ML model performance monitoring in accordance with embodiments of the present invention. FIG. 5 assumes that the UE 400 is configured or preconfigured with one or more predictive AI/ML models which is trained with a predefined dataset during a training phase 500 lasting from a time t1 to a time t2. At the time t2, the inference/prediction phase 502 starts. During the training phase 500 and the inference/prediction phase 502 values predicted by the AI/ML model are compared to measured values so as to monitor the performance of the predictive AI/ML model. FIG. 5 illustrates upper and lower thresholds 504a, 504b defining a range within which the results of the comparison of the predicted and measured values has to lay so as to confirm that the AI/ML model’s performance meets the requirements. For example, the comparison results c₁ to c₄ are well within the thresholds 504a, 504b, i.e., the AI/ML model operates properly until a time t₃ at which an outliers c₅ occurs, i.e., the comparison result c₅ is outside the range defined by the thresholds 504a, 504b.

In the embodiment of FIG. 5, the mismatch or deviation from a mean value 506 exceeds the threshold 504a, 504b once which may trigger a reporting of the mismatch. Besides reporting the mismatch, also a magnitude of the mismatch from the mean value 506 may be reported, and dependent on the magnitude of the mismatch, it may be decided that the AI/ML model needs a retraining or an extensive retraining. For example, extensive retraining may comprise using, when compared to a retraining, more or additional data, or a plurality of datasets, or data of a higher quality. For example, in case the magnitude or deviation exceeds a first threshold, only a retraining using a subset of data and/or data of lower quality may be initiated, while in a situation in which the magnitude or deviation exceeds a second threshold being higher than the first threshold, an extensive retraining may be initiated. In accordance with further embodiments, in case the magnitude of mismatch or deviation exceeds a third threshold being even higher than the second threshold, a change of the AI/ML model used for the prediction may be initiated.

In accordance with embodiments, the reporting of the mismatch may be performed once it occurs, for example responsive to a first mismatch encountered during a certain time interval. In accordance with other embodiments, the report may be triggered once a number of mismatches within a certain interval exceeds a predefined number or threshold, or in case the magnitude of mismatch or deviation , which has been averaged over a certain time interval, exceeds a certain threshold. Thus, according to embodiments, the performance report for the predictive AI/ML model may include one or more of the following: one or more adaption parameters to re-align the predictive AI/ML model, an AI/ML model update after re-training, a magnitude of the mismatch, e.g., mismatch between one or more of the predicted values, an indication that a re-training of the predictive AI/ML model is required, a request for changing from the predictive AI/ML model to a currently inactive predictive AI/ML model also monitored by the UE, a confirmation that the UE switched or will switch from the predictive AI/ML model to a currently inactive predictive AI/ML model also monitored by the UE.

In accordance with yet further embodiments, the mismatch report may be triggered and transmitted responsive to any of the above-described events.

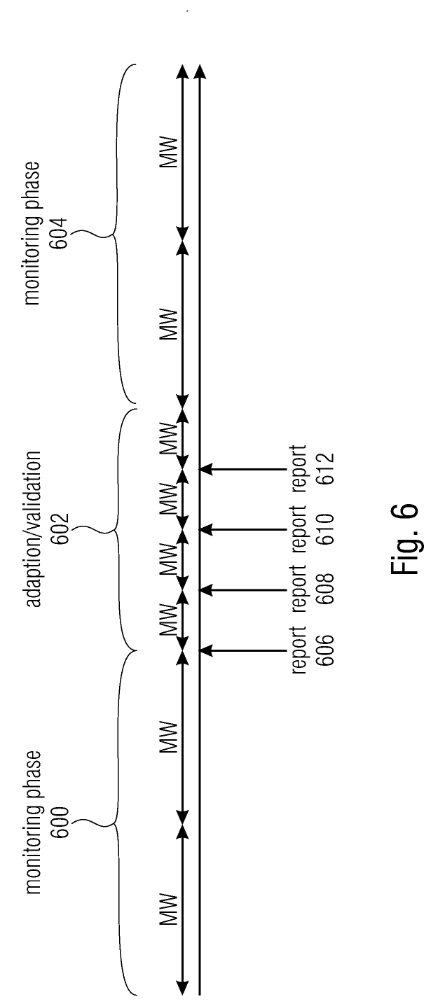

In accordance with yet further embodiments of the present invention, the UE may monitor an AI/ML model or an AI functionality during two or more phases, i.e., during a plurality of monitoring phases. FIG. 6 illustrates an embodiment for a multiple phase monitoring process performed by the UE 400 of FIG. 3. As is depicted in FIG. 6, there is a first monitoring phase 600 followed by a second monitoring phase 602, also referred to as an adaption/validation phase, during which the UE 400 adapts and/or validates the one or more active AI/ML models or functionalities. The two first monitoring phase 600 and the adaption/validation phase 602 are different in that the first monitoring phase 600 is less stringent in terms of the performance monitoring configuration than the adaption/validation phase 602. For example the above-mentioned measurement window may be shorter and/or less frequent in the first monitoring phase 600 than in the adaption/validation phase 602. In accordance with other embodiments, the thresholds for triggering the performance reporting may be smaller or larger in the respective phases meaning the phase with the smaller threshold is being less strict. In accordance with yet further embodiments, the number of KPIs which is measured and used for monitoring may be less during the first monitoring phase 600 than in the adaption/validation phase 602. As is depicted in FIG. 6, in accordance with embodiments, the adaption/validation phase 602 may be followed by a further monitoring phase 604 which may have the same properties as the first monitoring phase 602.

In accordance with further embodiments, the first monitoring phase 600 comprises of monitoring only, and the adaption/validation phase 602 comprises of updating the AI/ML model parameters and monitoring.

The adaption/validation phase 602 may have shorter measurement windows at the end of which respective reports 608 to 612 are generated with the thresholds and/or reporting conditions being lower/looser. Dependent on the configured conditions, the reports 600 to 612 may be transmitted on every occasion indicated or at some of the occasions indicated. In FIG. 6, one may see that the monitoring phases 600, 604 have the respective monitoring windows MW which are of equal duration while the adaption/validation phase 602 uses shorter measurement windows MW.

In accordance with embodiments, adapting the AI/ML model or functionalities may a switch of the AI/ML model and/or an update the AI/ML model parameters.

The UE 400 may switch between the first monitoring phase and the second monitoring phase responsive to one or more conditions, e.g., one or more of the following: A change in an AI/ML model configuration. A triggering of a performance report. A time condition, e.g., based on a configured or preconfigured timer so that the switching occurs periodically based on the timer, periodically or aperiodically. An indication from the network or from another UE. If one of the determined performance metrics exceeds a configured or preconfigured threshold. If one of the determined performance metrics exceeds a configured or preconfigured threshold and at least a further one of the determined performance metrics exceeds a configured or preconfigured threshold. If one or more of the determined performance metrics exceed a configured or preconfigured threshold for a configured or preconfigured time. If one or more performance metrics for an inactive AI/ML model exceed the corresponding performance metrics for an active AI/ML model by a configured or preconfigured threshold. If a number or percentage of performance metric outliers and/or a magnitude of the outliers exceeds a configured or preconfigured threshold. If a time since one or more of an activation of the AI/ML model for which the performance report is to be triggered, or a switch to the AI/ML model for which the performance report is to be triggered, or a change of parameters of the AI/ML model for which the performance report is to be triggered, or a last performance report for the AI/ML model was triggered exceeds a configured or preconfigured minimum time.

In accordance with further embodiments, the UE 400 may switch from the second monitoring phase to the first monitoring phase dependent on a battery lifetime of the UE, e.g., in case the UE has battery limitations, e.g., is low on battery.

In accordance with other embodiments, no such adaption/validation phase exists, and the second phase may only have a different monitoring configuration than the first phase.

In accordance with embodiments, the plurality of monitoring phases may be used responsive to one or more conditions, e.g., responsive to a change in an AI/ML model configuration or after triggering an initial performance report.

The UE may be configured with the plurality of monitoring phases via a performance monitoring configuration or via a separate pre-configuration, or it may the UE is to receive a signaling indicating whether the plurality of monitoring phases are to be used or not to be used during monitoring.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof. Further, the wireless communication system may by a system or network different from the above described 4G or 5G mobile communication systems, rather, embodiments of the inventive approach may also be implemented in any other wireless communication network, e.g., in a private network, such as an Intranet or any other type of campus networks, or in a WiFi communication system.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, like a station (STA), access point (AP), node or mesh node, or mesh point, or Mesh AP, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a Wi-Fi device such as an access point (AP) or mesh node (Mesh AP), or a remote radio head, or an AMF, or a MME, or a SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear, that these aspects also represent a description of the corresponding method, where a block or a device corresponds to a method step or a feature of a method step. Analogously, aspects described in the context of a method step also represent a description of a corresponding block or item or feature of a corresponding apparatus.

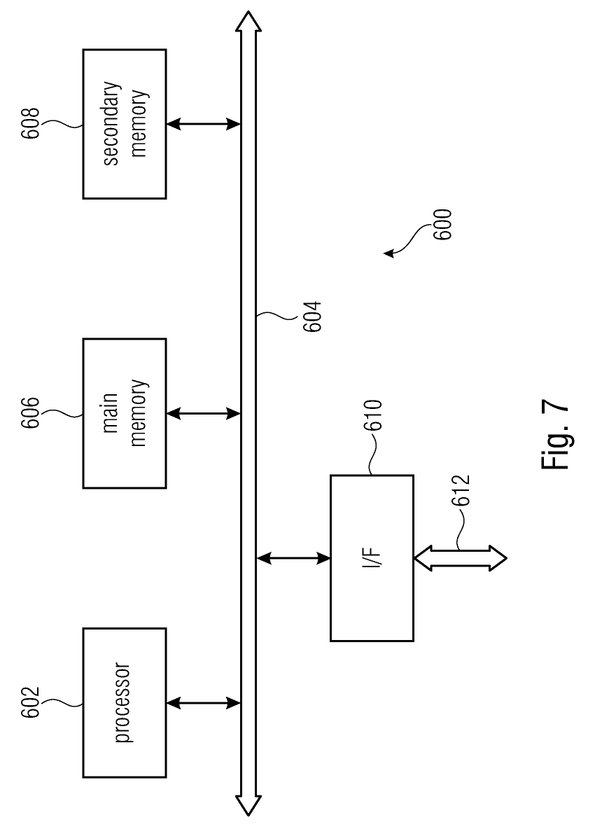

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 7 illustrates an example of a computer system 900. The units or modules as well as the steps of the methods performed by these units may execute on one or more computer systems 900. The computer system 900 includes one or more processors 902, like a special purpose or a general-purpose digital signal processor. The processor 902 is connected to a communication infrastructure 904, like a bus or a network. The computer system 900 includes a main memory 906, e.g., a random-access memory, RAM, and a secondary memory 908, e.g., a hard disk drive and/or a removable storage drive. The secondary memory 908 may allow computer programs or other instructions to be loaded into the computer system 900. The computer system 900 may further include a communications interface 910 to allow software and data to be transferred between computer system 900 and external devices. The communication may be in the from electronic, electromagnetic, optical, or other signals capable of being handled by a communications interface. The communication may use a wire or a cable, fiber optics, a phone line, a cellular phone link, an RF link and other communications channels 912.

The terms “computer program medium” and “computer readable medium” are used to generally refer to tangible storage media such as removable storage units or a hard disk installed in a hard disk drive. These computer program products are means for providing software to the computer system 900. The computer programs, also referred to as computer control logic, are stored in main memory 906 and/or secondary memory 908. Computer programs may also be received via the communications interface 910. The computer program, when executed, enables the computer system 900 to implement the present invention. In particular, the computer program, when executed, enables processor 902 to implement the processes of the present invention, such as any of the methods described herein. Accordingly, such a computer program may represent a controller of the computer system 900. Where the disclosure is implemented using software, the software may be stored in a computer program product and loaded into computer system 900 using a removable storage drive, an interface, like communications interface 910.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication network,
wherein the UE is configured or preconfigured with at least one Artificial Intelligence/Machine Learning model, AI/ML model, or at least one AI functionality for performing one or more tasks,
wherein the UE is to monitor a performance of one or more AI/ML models or one or more AI functionalities, and
wherein the UE is to perform one or more actions.

2. The user device, UE, of claim 1, wherein the one or more actions comprise of one or more of the following:
switch to a further AI/ML model for performing the one or more tasks,
trigger a performance report for the AI/ML model or the AI functionality,
send a performance report for the AI/ML model or the AI functionality,
provide am AI/ML related signaling to the wireless communication network,
stop using the AI/ML model for performing the one or more tasks.

3. The user device, UE, of claim 2, wherein the AI/ML related signaling to the wireless communication network comprises one or more of the following:
an indication that a calculation using the AI/ML model is infeasible, e.g., due to a complexity of the model or due to a battery lifetime of the UE,
an AI/ML model identification, ID, of a new AI/ML model to be acquired from the wireless communication network comprises for performing the one or more tasks,
a request for new training data to be used for training the AI/ML model,

4. The user device, UE, of claim 1, wherein, for monitoring a performance of the AI/ML model, the UE is to determine one or more performance metrics for one or more key performance indicators, KPIs.

5. The user device, UE, of claim 4, wherein the one or more KPIs comprise one or more of the following:
an inference accuracy, e.g., indicated as a normalized mean square error, NMSE, and/or as a squared generalized cosine similarity, SGCS,
a system performance, e.g., indicated by a throughput, like a mean user perceived throughput, UPT, a block error rate, BLER, a packet error rate, PER, by a number or ratio of acknowledgements/non-acknowledgements, ACK/NACK, or a number of non-acknowledgements, NACKs, in case of NACK-only, by a latency-related information, e.g., measured in milliseconds or frame-rates, like radio frame or subframe, by switching cycles, e.g., TDD switching cycles, or by a handover success or failure rate, and the like,
a data distribution, e.g., indicated as a maximum, minimum or mean value or a variance or standard deviation of the amount of data received or transmitted.

6. The user device, UE, of claim 4, wherein the UE is to determine the one or more performance metrics over a configured or preconfigured measurement window defining
a time over which the determined performance metrics are averaged or aggregated or combined, and/or
a number of determined performance metrics to be averaged or aggregated or combined.

7. The user device, UE, of claim 4, wherein the UE is to extend or shorten the measurement window depending on one or more of: a certain amount of measurements, a certain amount of measurement outliers, a certain amount of values inside a confidence interval, a confidence interval, an error magnitude or error vector magnitude, EVM.

8. The user device, UE, of claim 1, wherein the UE is to provide the performance report to one or more entities of the wireless communication network, e.g., to another UE or to a Radio Access Network, RAN, entity, like a gNB, or to a core network, CN, entity.

9. The user device, UE, of claim 8, wherein the UE is to provide the performance report
periodically, or
responsive to the certain event.

10. The user device, UE, of claim 1, wherein the performance report comprises data representing the determined performance metrics, e.g., one or more of the following:
processed, e.g., averaged or aggregated or combined, performance data representing one or some or all of the determined performance metrics, or
non-processed performance data representing one or some or all of the determined performance metrics,
specific performance data representing only a proper subset of the determined performance metrics, e.g., only outliers or an average of the outliers, like an error magnitude of the outliers.

11. The user device, UE, of claim 10, wherein the performance report further comprises one or more of the following:
an index, like an integer, representing an index of a performance report configuration with which the UE is configured,
any decision related to a conditional monitoring model switch/past decisions, e.g., a list of AI/ML monitored models related to past actions over a period of time,
one or more timestamps.
measurement window parameters, like a duration or length, a number of samples, a confidence interval,

12. The user device, UE, of claim 1, wherein
the AI/ML model is a predictive AI/ML model, and
the UE is to monitor a performance of the predictive AI/ML model by comparing one or more predicted values acquired from the predictive AI/ML model and one or more corresponding measured values acquired by the UE.

13. The user device, UE, of claim 12, wherein the performance report for the predictive AI/ML model comprises one or more of the following:
one or more adaption parameters to re-align the predictive AI/ML mode,
an AI/ML model update after re-training,
a magnitude of the mismatch, e.g., mismatch between one or more of the predicted values and the more corresponding measured values,
an indication that a re-training of the predictive AI/ML model is required,
a request for changing from the predictive AI/ML model to a currently inactive predictive AI/ML model also monitored by the UE,
a confirmation that the UE switched or will switch from the predictive AI/ML model to a currently inactive predictive AI/ML model also monitored by the UE.

14. The user device, UE, of claim 1, wherein
the UE is to monitor the AI/ML model during a plurality of monitoring modes, and
the plurality of monitoring modes comprises a first monitoring mode comprising a monitoring configuration which is different from a monitoring configuration of a second monitoring mode.

15. The user device, UE, of claim 14, wherein the UE is to adapt and/or validate the one or more active AI/ML models or functionalities during the second monitoring mode.

16. The user device, UE, of claim 14, wherein
the UE is configured with the plurality of monitoring modes via a performance monitoring configuration or via a separate pre-configuration, or
the UE is to receive a signaling indicating whether the plurality of monitoring modes are to be used or not to be used during monitoring.

17. The user device, UE, of claim 1, wherein the UE is to receive a performance report configuration for configuring the reporting of the AI/ML model.

18. The user device, UE, of claim 17 wherein the performance report configuration comprises one or more of the following:
an index, like an integer, representing the performance report configuration,
an AI/ML model identification, ID, like a model identification number, indicating for which AI/ML model the performance report is to be provided,
an AI/ML-model mode indicating whether the performance report is to be provided for an active or inactive AI/ML-model,
the one or more performance metrics,
the one or more thresholds for the performance metrics that trigger the performance report,
one or more reporting conditions triggering the performance report,
a reporting periodicity,
a measurement window size,
one or more thresholds for allowing switching to an inactive AI/ML model to be monitored,
a hysteresis to avoid switching between AI/ML models during a certain time after the last switch or before an additional delta threshold is exceeded since the last switch.

19. The user device, UE, of claim 1, wherein the one or more of tasks comprise one or more of the following:
AI/ML model based access to a RAN,
AI/ML model based network energy saving,
an AI/ML model based mobility optimization,
AI/ML model based use cases, like
o channel state information, CSI, feedback, like a CSI compression and/or a CSI prediction, or
o beam management, or
o positioning, like a direct AI/ML positioning (e.g., fingerprinting) and/or an AI/ML assisted positioning,
AI/ML model based mobility management, e.g., a handover, HO, prediction and/or conditional handover, CHO, prediction,
AI/ML model based modulation and coding scheme, MCS, selection,
AI/ML model based synchronization,
AI/ML model based encoding and/or decoding and/or precoding,
AI/ML model based modulation and/or demodulation,
AI/ML model based positioning or ranging,
AI/ML model based joint communication and sensing, JSAC,
AI/ML model based feedback calculation, e.g., CSI/CQI/PMI/RI feedback,
AI/ML model based interference management,
AI/ML model based quality of experience, QoE, and/or quality of service, QoS, predictions,
AI/ML model based network traffic forecasting.

20. A method for operating a user device, UE, for a wireless communication network, wherein the UE is configured or preconfigured with at least one Artificial Intelligence/Machine Learning model, AI/ML model, or at least one AI functionality for performing one or more tasks, the method comprising:
monitoring, by the UE, a performance of one or more AI/ML models or one or more AI functionalities, and
performing, by the UE one or more actions.
